(19) United States
(12) Patent Application Publication
(10) Pub. No.: US 2026/0203602 A1
(43) Pub. Date: Jul. 16, 2026

(54) DISCRETE MONOTONIC ENTITY RESOLUTION MODELS

(71) Applicant: Capital One Services, LLC, McLean, VA (US)

(72) Inventors: Jeffrey GABLER, New York, NY (US); Benjamin COOK, McLean, VA (US)

(73) Assignee: Capital One Services, LLC, McLean, VA (US)

(21) Appl. No.: 19/020,335

(22) Filed: Jan. 14, 2025

(51) Int. Cl. G06N 5/022; G06F 16/901; G06F 18/241

(52) U.S. Cl. CPC G06N 5/022; G06F 16/9017; G06F 16/9024; G06F 18/241

(57) ABSTRACT

Systems and methods for performing entity resolution. In some aspects, the system uses a plurality of attributes represented in a plurality of records to construct a feature vector for pairs of records based on whether corresponding attributes between pairs of records in the plurality of records match. The system generates a directed graph of the feature vectors where nodes represent feature vectors and edges connect nodes if the preceding feature vector has fewer matches than the subsequent feature vector. When the similarity between feature vectors of node pairs satisfies a threshold, the system merges reachable feature vectors in the directed graph. The system can generate a lookup table from the remaining feature vectors in the modified graph, mapping each to a classification of either matching or non-matching entities. The system merges pairs of records with a corresponding classification from the lookup table that the pair of records are matching entities.

### SUMMARY

Entity resolution, also known as record linkage or deduplication, is the process of identifying and merging records or data points that refer to the same real-world entity or individual. In other words, entity resolution is the process of identifying and linking together multiple records that refer to the same person, company, organization, or other entity. Entity resolution is particularly important in situations where data is collected from multiple sources or systems, as entity resolution can eliminate duplicates and inconsistencies in the data and create a more accurate and comprehensive picture of the entities in question. Entity resolution is used in a variety of fields, including healthcare, finance, marketing, and law enforcement, among others.

The entity resolution process is a complex computational problem that involves identifying and merging records or data points that refer to the same real-world entity. At its core, the technical problem includes comparing pairs of records and determining whether the records refer to the same entity or not. This comparison is typically based on some form of similarity measure, such as string matching or feature-based comparison, and includes evaluating various attributes or fields of the records. The technical nature of the entity resolution problem is further complicated by a number of factors, including the absence of a perfect source of truth, and the inaccuracies introduced by approximations in target labels, and the low interpretability of conventional entity resolution models.

Conventional systems sometimes use external labels or previous system outputs as training data for entity resolution models, which can lead to inaccuracies due to the imperfections in the labels. For example, conventional systems sometimes rely on supervised learning techniques that may produce illogical results, such as considering entities with fewer matching attributes as more likely to match than those with more matching attributes. The technical problem may arise because the training data, whether sourced externally or generated by previous entity resolution systems, may contain errors and inconsistencies. For instance, different data sources can use slightly different formats or conventions for the same attribute, leading to mismatches that are not truly indicative of different entities. The imperfections can mislead the model during the training phase, causing the model to learn incorrect patterns and make flawed predictions. As a result, the model may incorrectly classify entities with fewer matching attributes as more likely to match, which contradicts the logical expectation that more matching attributes should indicate a higher likelihood of a match. The illogical prediction not only reduces the accuracy of the entity resolution process but also causes the model's decisions to be difficult to justify, especially in contexts where transparency and defensibility are important to the organization, such as in regulatory compliance and fraud detection.

In some aspects, to address one or more of the technical problems described above, systems and methods are described herein for performing entity resolution for a plurality of records by training an entity resolution model based on discrete, low cardinality features with a natural ordering. The system can, for example, train a supervised model on the incomplete or disorganized data and adjust the model using by imposing a domain-specific belief in the form of a monotonicity constraint, thereby maintaining logical consistency. The systems and methods described herein can recursively classify feature vectors in a partially ordered feature vector graph with more matching attributes as at least as likely to represent matching entities as those with fewer matching attributes. By imposing the domain-specific belief on the model, the system improves the accuracy and reliability of the entity resolution process and generates more interpretable and defensible predictions.

In some implementations, the system uses a plurality of attributes represented in a plurality of records to construct a feature vector for each pair of records based on whether corresponding attributes between pairs of records in the plurality of records match. The system generates a directed graph of the constructed feature vectors where nodes represent feature vectors and edges connect nodes if the preceding feature vector has fewer matches than the subsequent feature vector. When the similarity between feature vectors of node pairs satisfies a threshold, the system merges reachable feature vectors in the directed graph. The system can generate a lookup table from the remaining feature vectors in the modified graph, mapping each to a classification of either matching or non-matching entities. The system merges pairs of records of the plurality of records for each feature vector having a corresponding classification from the lookup table that the pair of records for the feature vector are matching entities.

Various other aspects, features, and advantages of the disclosure will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an example environment for performing entity resolution for a plurality of records, in accordance with one or more implementations.

FIG. 2A shows an illustrative example of performing entity resolution for a plurality of records using an illustrative graph of partially ordered features of the plurality of records, in accordance with one or more implementations.

FIG. 2B shows an illustrative example of training entity resolution models using monotonicity constraints on the illustrative graph of FIG. 2A, in accordance with one or more implementations.

FIG. 3 shows an exemplary lookup table for illustrating a process for performing entity resolution for a plurality of records, in accordance with one or more implementations.

FIG. 4 is an illustrative architecture for a system for facilitating performing entity resolution for a plurality of records, in accordance with one or more implementations.

FIG. 5 shows a flowchart of the operations involved in performing entity resolution for a plurality of records, in accordance with one or more implementations.

### DETAILED DESCRIPTION

In the following description, for the purposes of explanation, numerous specific details are set forth in order to provide a thorough understanding of the implementations of the systems and methods described herein. It will be appreciated, however, by those having skill in the art, that the implementations may be practiced without these specific details or with an equivalent arrangement. In other cases, well-known structures and devices are shown in block diagram form in order to avoid unnecessarily obscuring the implementations.

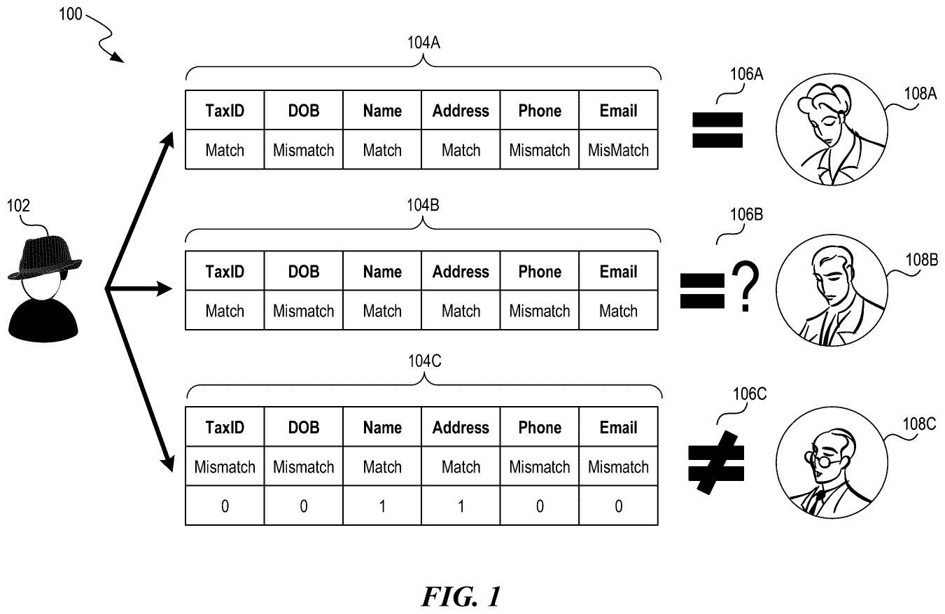

FIG. 1 shows an example environment 100 for performing entity resolution for a plurality of records, in accordance with one or more implementations. The example environment 100 includes unidentified entity 102, feature vectors 104 (e.g., first feature vector 104A, second feature vector 104B, third feature vector 104C), matching indicators 106 (e.g., first matching indicator 106A, second matching indicator 106B, third matching indicator 106C), and candidate entities 108 (e.g., first candidate entity 108A, second candidate entity 108B, third candidate entity 108C). Implementations of the example environment 100 can include different and/or additional components or can be connected in different ways.

Today's customer databases are typically indexed by account, not by person. For example, a multi-account customer may have one demographic record per account. The product of an entity resolution system is a mapping from customer references (such as account-level records) to unique customers. This mapping can be expressed in an enterprise customer identifier, which is a key that is equal among records that refer to the same person. Entity resolution models can be trained by use of a pre-existing key, such as from a prior entity resolution system or from external data such as a person identifier provided by a consumer credit reporting bureau.

For example, the feature vectors 104 in FIG. 1 can be thought of as an indicator of whether sets of attributes or features match between the unidentified entity (i.e., an account labeled by a particular enterprise customer identifier) and candidate entities (i.e., accounts labeled by a different enterprise customer identifier). For example, in FIG. 1, the first candidate entity 108A matches the features of TaxID, name, and address with the unidentified entity 102; the second candidate entity 108B matches the features of TaxID, name, and address, and email with the unidentified entity 102; and the third candidate entity 108C matches just the features of name and address with the unidentified entity 102. The matching indicator 106 in FIG. 1 indicates the degree of confidence in whether the attributes represent matching entities.

In some implementations, systems for performing entity resolution seek to answer the question whether the two customers represented in FIG. 1 (e.g., the unidentified entity 102 and the candidate entities 108) should be considered the same person for a particular process. For example, an exemplary non-limiting list of processes may include servicing, marketing, fraud investigation, and anti-money laundering. In particular, the technical nature of this entity resolution problem can be presented as what is the minimally required information to uniquely identify a person/customer, the likely match outcome, and confidence regarding matches found. For example, in FIG. 1, the first matching indicator 106A indicates that the unidentified entity 102 matches with the first candidate entity 108A, which can mean that although unidentified entity 102 may be classified under a different enterprise customer identifier than the first candidate entity 108A, the two entities should be considered the same person for the particular process. On the other hand, the third matching indicator 106C in FIG. 1 indicates that the unidentified entity 102 does not match with the third candidate entity 108C, which can mean that the two entities should not be considered the same person for the particular process.

The described systems and methods address the challenges not addressed by existing solutions, including the absence of a perfect source of truth, and the inaccuracies introduced by approximations in target labels, and the low interpretability of conventional entity resolution models. One of the primary challenges in entity resolution is the absence of a perfect source of truth. Any target label a model is created on is itself an approximation—whether it is an externally sourced label or the output of a previous entity resolution system. The labels often lack the precision needed for accurate model training, as the labels may not capture all the nuances and variations present in the data. For instance, different data sources can use slightly different formats or conventions for the same attribute, leading to mismatches that are not truly indicative of different entities. Further, the inaccuracies introduced by approximations in target labels further complicate the entity resolution process. Conventional entity resolution models often rely on the inaccurate external labels or previous system outputs to create supervised models that produce unexpected, “illogical” conclusions. For example, a conventional entity resolution model can consider entities with fewer matching attributes as more likely to match than those with more matching attributes. Additionally, the low interpretability of conventional entity resolution models presents further challenges. Conventional entity resolution models often include complex algorithms and high-dimensional feature vectors, making the models difficult to understand and explain. For example, a model with n binary attributes can generate 2\hat{ }n possible feature vectors, each representing a different combination of attribute matches and mismatches. The exponential growth in complexity makes it challenging to interpret the model's decisions and understand why certain records are considered matches or non-matches. Individuals and organizations may struggle to justify the model's outcomes, especially in applications where transparency and accountability are expected.

To address the above-described technical challenges, the described systems and methods present an entity resolution model trained based on discrete, low cardinality features with a natural ordering. In some aspects, systems and methods are described herein for performing entity resolution for a plurality of records. The system obtains a plurality of records from one or more sources. The system determines a plurality of attributes represented in the plurality of records. In some aspects, the system uses a plurality of attributes represented in a plurality of records to construct a feature vector for pairs of records based on whether corresponding attributes between pairs of records in the plurality of records match. The system generates a directed graph of the feature vectors where nodes represent feature vectors and edges connect nodes if the preceding feature vector has fewer matches than the subsequent feature vector. When the similarity between feature vectors of node pairs satisfies a threshold, the system merges reachable feature vectors in the directed graph. The system can generate a lookup table from the remaining feature vectors in the modified graph, mapping each to a classification of either matching or non-matching entities. The system merges pairs of records with a corresponding classification from the lookup table that the pair of records are matching entities.

The proposed system and method ensure that feature vectors (e.g., feature vectors 104) with more matching attributes are classified as at least as likely to represent matching entities as those with fewer matching attributes. After the initial classification, the system adjusts the entity resolution model by recursively applying a monotonicity constraint. The monotonicity constraint can constrain the model's output to consistently increase or remain the same with respect to an increase in the input features. For example, in entity resolution, if one record pair has more matching attributes than another, the monotonicity constraint constrains the model so that the model does not classify the former as less likely to match than the latter.

In the proposed system and method, for each positively classified feature vector, the system also classifies its neighboring feature vectors (those with one additional matching attribute) as positive, regardless of their initial classification. The recursive process can continue until all feature vectors that should logically be classified as positive are correctly labeled, thereby maintaining a consistent and logical progression in the model's classifications. For example, in FIG. 1, according to the domain-specific belief that increasing the number of matching attributes should increase the likelihood of a match, if the second candidate entity 108B, which matches the features of TaxID, name, and address, is classified as “matching,” then the first candidate entity, which matches the features of TaxID, name, address, and further email, should also be classified as “matching” to ensure a logical and consistent entity resolution model, as entities with more matching attributes should not be considered less likely to match than those with fewer matching attributes.

In some implementations, constructing the feature vector for each pair of records includes using one or more models to determine whether the corresponding attributes between the pairs of records match. The models can include decision trees, random forests, Bayesian networks, support vector machines, and/or logistic regression models. For example, a decision tree can classify attributes as matching or non-matching based on predefined rules. The decision tree model can evaluate each attribute by traversing a series of decision nodes, where each node represents a condition on an attribute. If the condition is met, the model moves to the next node; otherwise, it follows an alternative path. The process can continue until a leaf node is reached, which provides the classification of the attribute as either matching or non-matching. Random forests, which are ensembles of decision trees, can further be used to determine attribute matches. Each tree in the forest independently classifies the attributes, and the final decision can be made based on the majority vote of all the trees. The ensemble approach reduces the risk of overfitting.

On the other hand, a logistic regression model can assign probabilities to attribute matches using a logistic function to estimate the probability that a given attribute pair matches. The logistic regression model can consider the weighted sum of the input attributes, where each attribute is assigned a weight based on its importance, and apply the logistic function to the weighted sum to produce a probability score between 0 and 1. If the probability exceeds a certain threshold, the attribute pair can be classified as a match; otherwise, the attribute can be classified as a non-match. Bayesian networks, which represent probabilistic relationships among attributes, can model the dependencies between attributes and use these relationships to infer the likelihood of matches. Support vector machines can classify attributes by finding the hyperplane that separates matching and non-matching attribute pairs in a high-dimensional space. Further, each model can assign a weight to the attributes, biasing the determination towards higher-weighted attributes. For instance, if the “Name” attribute is considered more important than the “Address” attribute, the model can assign a higher weight to the “Name” attribute.

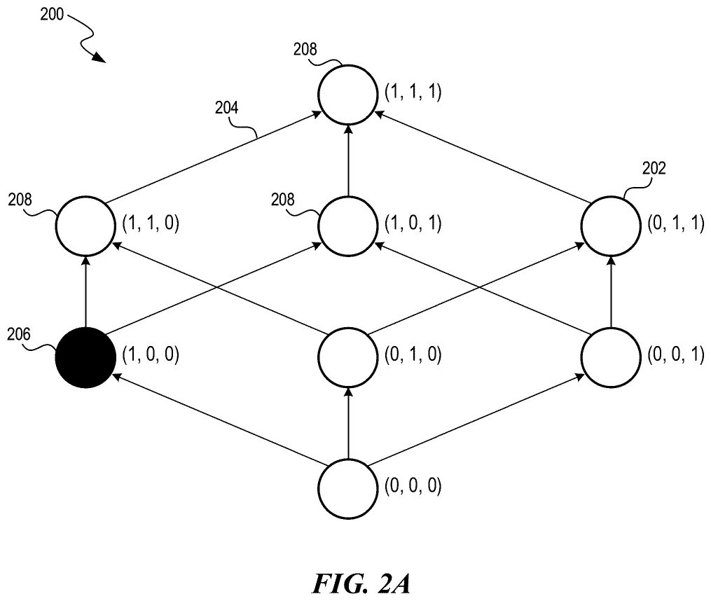

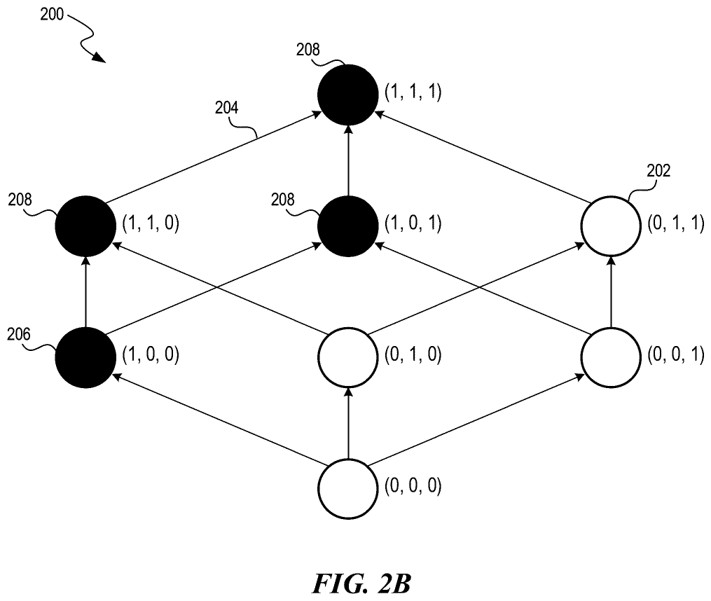

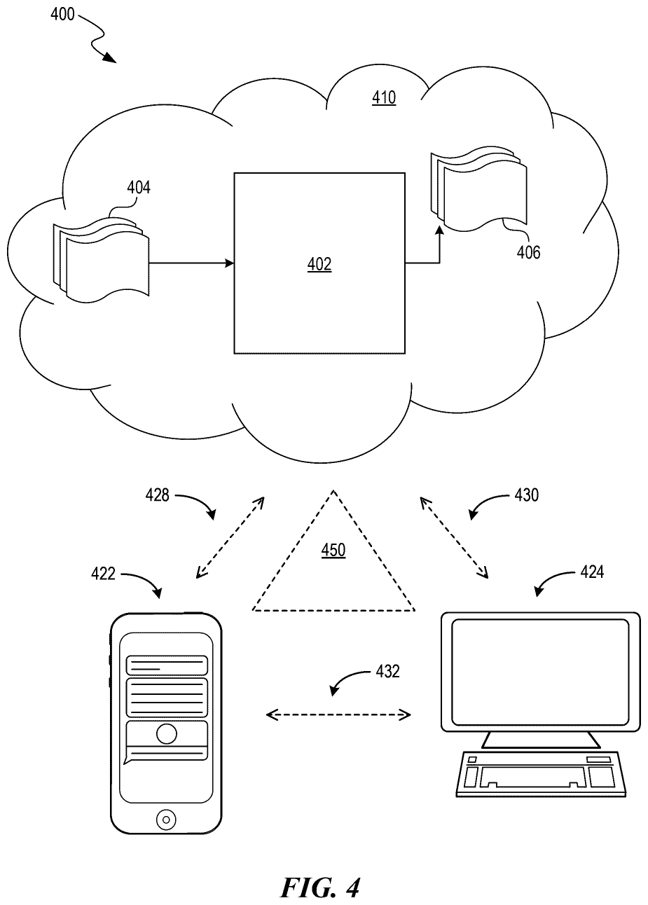

The enumeration of the feature vectors 104 in FIG. 1 enables the creation of a directed graph where each feature vector is a node, and edges point to feature vectors with one additional matching attribute. FIG. 2A shows an illustrative example of performing entity resolution for a plurality of records using an illustrative graph 200 of partially ordered features of the plurality of records, in accordance with one or more implementations. Graph 200 includes nodes 202, edges 204, matched feature vectors 206, and reachable feature vectors 208. The graph 200 can be implemented using components of example mobile devices 422 and user terminals 424 illustrated and described in more detail with reference to FIG. 4. Implementations of graph 200 can include different and/or additional components or can be connected in different ways.

To generate graph 200, the proposed system can group record pairs that match on the same set of attributes (regardless of the specific value for each attribute). Each distinct set of matching/non-matching attributes can be referred to as a feature vector (e.g., feature vector 104) and can be thought of as a vector of discrete model features. Within each feature vector group, some fraction of the individual record pairs can be positively classified (matching, or indicating belonging to the same entity) or negatively classified (non-matching, or indicating not belonging to the same entity). The fraction can be determined by either a prior target (such as an externally sourced identifier one may want to emulate) for a supervised model or an inferred Bayesian prior informed by the historic background data (such as proportion of overall matches) supplemented by a relatively small number of manual labels for a semi-supervised approach.

Graph 200 is a directed graph used to represent the relationships between feature vectors derived from pairs of records. Each node 202 in the graph represents a feature vector, which is a representation (e.g., binary, trinary, and so forth) of whether corresponding attributes between pairs of records match. For example, a binary feature vector (1, 0, 0) indicates that the first attribute matches while the second and third attributes do not. Edges 204 in the graph 200 can indicate a relationship between nodes 202 where the preceding node has fewer matching attributes than the subsequent node. For instance, an edge 204 from a node 202 representing the binary feature vector (1, 0, 0) to a node representing (1, 1, 0) can indicate that the latter has one more matching attribute than the former. The structure enables the graph 200 to represent the partial ordering of feature vectors based on the number of matching attributes. Matched feature vectors 206, such as (1, 0, 0), can indicate that certain attributes match between the pair of records and provide a reference point for evaluating other feature vectors. The graph 200 is constructed by creating nodes for each feature vector and connecting them with edges based on the number of matching attributes. For example, a node representing the feature vector (1, 0, 0) can have edges pointing to nodes representing (1, 1, 0) and (1, 0, 1), as these vectors have one additional matching attribute.

FIG. 2B shows an illustrative example of training entity resolution models using monotonicity constraints on the illustrative graph 200 of FIG. 2A, in accordance with one or more implementations. The graph 200 can be modified by merging nodes based on a predefined similarity threshold. If the degree of similarity between feature vectors of a particular pair of nodes satisfies the threshold, the system merges reachable feature vectors from the node of the particular feature vector in the directed graph. Reachable feature vectors 208, such as (1, 1, 0), (1, 0, 1), and (1, 1, 1) represent pairs of records with varying degrees of attribute matches. The vectors are reachable from the matched feature vector 206 through edges 204, indicating that they have (at least) one additional matching attribute. For instance, if a node representing the feature vector (1, 0, 0) has edges pointing to nodes representing (1, 1, 0), (1, 0, 1), and (1, 1, 1) and the similarity between the feature vector (1, 0, 0) satisfies the threshold, the system merges the nodes containing the feature vectors (1, 0, 0), (1, 1, 0), (1, 0, 1), and (1, 1, 1). In some implementations, for binary features, the system can determine whether the particular pair of nodes should be merged by checking if the discrete features of both nodes are equal to one. For trinary features, the system can determine if the discrete features of both nodes are equal to two before merging them. For example, a binary feature vector (1, 0, 0) can indicate that the first attribute matches while the second and third do not, whereas a trinary feature vector (2, 1, 0) can indicate an exact match, a partial match, and no match, respectively.

In some implementations, the directed graph 200 is modified based on whether the feature vectors of the particular pair of nodes satisfy a predefined threshold, which can be determined using a majority vote between classifications of neighboring feature vectors. For example, if a feature vector (1, 0, 0) has neighboring feature vectors (1, 1, 0) and (1, 0, 1), and both neighbors are classified as matching entities, the system can merge the node representing (1, 0, 0) with its neighbors.

In some implementations, constructing the feature vector for each pair of records includes assigning a confidence score to each element of the feature vectors. The directed graph can be modified based on whether the feature vectors of the particular pair of nodes satisfy a predefined threshold, with the confidence score used to dynamically adjust the threshold. For example, if the confidence score for a feature vector element is high, the threshold for merging nodes can be lowered, allowing for more aggressive merging.

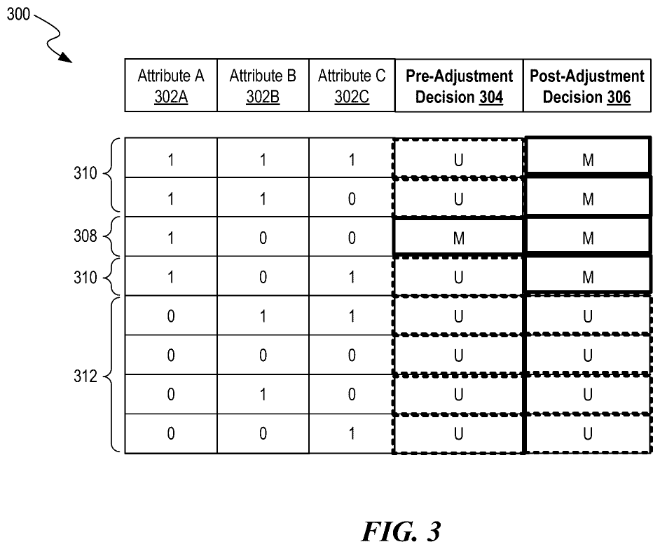

FIG. 3 shows an exemplary lookup table 300 for illustrating a process for performing entity resolution for a plurality of records, in accordance with one or more implementations. After modifying the directed graph, the system can generate the lookup table 300 (e.g., an entity resolution model) using the remaining feature vectors. The lookup table 300 includes feature vector attributes 302 (e.g., first attribute 302A, second attribute 302B, third attribute 302C), pre-adjustment decision 304, post-adjustment decision 306, matching feature vector 308, merged feature vectors 310, and non-merged feature vectors 312.

The lookup table 300 is a model that classifies feature vectors based on their likelihood of representing matching entities. The lookup table 300 can be generated before or after the directed graph has been modified (i.e., merging nodes in the graph based on a predefined similarity threshold). In the lookup table 300, each row corresponds to a specific feature vector and its associated attributes. These attributes can be binary, trinary, or other representations indicating the level of similarity between the records. In some implementations, the rows for the lookup table 300 can be consolidated into a data storage format and packaged into a text file, a CSV file, a JSON file, an XML file, or a YAML file, such as lookup table 300 shown in FIG. 3. YAML is a human-readable data-serialization language and can be used for configuration files and in applications where data is being stored or transmitted. Using the YAML file, the system generates SQL queries to generate all the record pairs which the proposed system can then use to create a graph using a connected components algorithm. SQL is a domain-specific language used in programming and designed for managing data held in a relational database management system or for stream processing in a relational data stream management system. The result of the SQL query can be a list of matching pairs, which can be sent to the connected components algorithm for producing final entity groups (e.g., unique customers or entities).

Matching feature vector 308 lists feature vectors that have been classified as indicating matching entities. The lookup table 300 maps each feature vector to a classification indicating either matching entities or non-matching entities. This mapping can be based on the degree of similarity between feature vectors and the predefined threshold used during the graph modification process. For example, if a feature vector (1, 1, 0) is classified as a matching feature vector, it indicates that the pair of records corresponding to this vector are likely to be matching entities. The lookup table 300 can be used to merge pairs of records that have a corresponding classification indicating they are matching entities. If a pair of records has a feature vector that matches an entry classified as a matching entity, the system merges these records.

In some implementations, the degree of similarity between the feature vectors of a particular pair of nodes is determined using a distance metric such as Jaccard similarity, Jaro-Winkler distance, Euclidean distance, and so forth. For example, Jaccard similarity measures the intersection over union of attribute sets, so if two feature vectors are (1, 0, 1) and (1, 1, 1), the Jaccard similarity would be ⅔. Jaro-Winkler distance accounts for typographical errors, so if the feature vectors are based on names “John” and “Jon”, the distance would be small, indicating high similarity. Euclidean distance measures the straight-line distance in a multi-dimensional space, so for feature vectors (1, 0, 0) and (1, 1, 0), the Euclidean distance would be one. In some implementations, the degree of similarity between the feature vectors of a particular pair of nodes is determined using cosine similarity, or using a measure the cosine of the angle between two vectors. For example, if the feature vectors are (1, 0, 1) and (1, 1, 1), the cosine similarity can be calculated as the dot product of the vectors divided by the product of their magnitudes.

In some implementations, mapping each remaining feature vector of the modified directed graph includes calculating the number of feature vectors reachable from the node of the remaining feature vector that are classified as matching entities, as well as the total number of reachable feature vectors. The classification of the remaining feature vector can be determined based on whether the fraction of matching feature vectors exceeds a predefined threshold. For example, if a feature vector (1, 0, 0) has three reachable feature vectors, and two of them are classified as matching entities, the fraction is ⅔. If the predefined threshold is 0.5, the feature vector (1, 0, 0) can be classified as a matching entity.

The pre-adjustment decision 304 column captures the initial classification of the feature vector before the monotonicity constraints are applied. The pre-adjustment decision 304 is based on the original directed graph and the relationships between the nodes representing the feature vectors. The post-adjustment decision 306 column reflects the classification after applying monotonicity constraints and merging nodes based on predefined similarity thresholds. Merged feature vectors 310 lists feature vectors that have been merged during the graph modification process (e.g., those reachable from the node of the matching feature vector 308). The merged feature vectors 310 can be combined with other feature vectors to form a more accurate representation of matching entities. Conversely, non-merged feature vectors 312 lists feature vectors that have not been merged during the graph modification process. The non-merged feature vectors 312 can be retained in their original form and are used to determine the final classification of entities.

In some implementations, the system biases towards classifications indicating non-matching entities by increasing the predefined threshold of the degree of similarity between the feature vectors of the particular pair of nodes. For example, if the initial threshold is 0.5, increasing it to 0.7 can make the system more conservative, reducing the likelihood of false positives. Conversely, in some implementations, the system biases towards classifications indicating matching entities by decreasing the predefined threshold of the degree of similarity between the feature vectors of the particular pair of nodes. For example, if the initial threshold is 0.5, decreasing it to 0.3 can make the system more inclusive, reducing the likelihood of false negatives. In some implementations, performance metrics such as precision, recall, and F1-score are used to evaluate the effectiveness of the initial threshold.

FIG. 4 is an illustrative architecture for system 400 for facilitating performing entity resolution for a plurality of records, in accordance with one or more implementations. As shown in FIG. 4, system 400 may include mobile device 422 and user terminal 424 (either type of device may be a “user device” as referred to herein, though a user device may additionally or alternatively include other types of devices as well). While shown as a smartphone and a personal computer, respectively, in FIG. 4, it should be noted that mobile device 422 and user terminal 424 may be any computing device, including, but not limited to, a laptop computer, a tablet computer, a hand-held computer, or other computer equipment (e.g., a server), including “smart,” wireless, wearable, and/or mobile devices. FIG. 4 also includes cloud components 410. Cloud components 410 may alternatively be any computing device as described above and may include any type of mobile terminal, fixed terminal, or other device. For example, cloud components 410 may be implemented as a cloud computing system and may feature one or more component devices. It should also be noted that system 400 is not limited to three devices. Users may, for instance, utilize one or more devices to interact with one another, one or more servers, or other components of system 400. It should be noted that, while one or more operations are described herein as being performed by particular components of system 400, those operations may, in some implementations, be performed by other components of system 400. As an example, while one or more operations are described herein as being performed by components of mobile device 422, those operations may, in some implementations, be performed by components of cloud components 410. In some implementations, the various computers and systems described herein may include one or more computing devices that are programmed to perform the described functions. Additionally, or alternatively, multiple users may interact with system 400 and/or one or more components of system 400. For example, in one implementation, a first user and a second user may interact with system 400 using two different components.

With respect to the components of mobile device 422, user terminal 424, and cloud components 410, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., based on output data received from system 400).

Additionally, as mobile device 422 is shown as a touchscreen smartphone, this display also acts as a user input interface. It should be noted that in some implementations, the devices may have neither user input interfaces nor displays and may instead receive and display content using another device (e.g., a dedicated display device such as a computer screen and/or a dedicated input device such as a remote control, mouse, voice input, etc.). Additionally, the devices in system 400 may run an application (or another suitable program). The application may cause the processors and/or control circuitry to perform operations related to generating dynamic database query responses using ensemble prediction by correlating probability models with non-homogenous time dependencies to generate time-specific data processing predictions.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communication networks or combinations of communication networks. Communication paths 428, 430, and 432 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include a server 402 for implementing one or more implementations described with respect to FIGS. 1-5. For example, server 402 may implement a portion or all of the functionality described with respect to FIGS. 1-5. Server 402 may receive input data 404 from mobile device 422, execute the operation to process the input data 404, and transmit output data 406 to user terminal 424. Cloud components 410 may also include control circuitry configured to perform the various operations needed to facilitate performing entity resolution for a plurality of records, according to one or more implementations.

In some implementations, cloud components 410 include an artificial intelligence model. The artificial intelligence model may take inputs and provide outputs. The inputs may include multiple datasets, such as a training dataset and a test dataset. In some implementations, the outputs may be fed back to the artificial intelligence model as input to train the artificial intelligence model (e.g., alone or in conjunction with user indications of the accuracy of the outputs, with labels associated with the inputs, or with other reference feedback information). For example, the system may receive a first labeled feature input, wherein the first labeled feature input is labeled with a known prediction for the first labeled feature input. The system may then train the artificial intelligence model to classify the first labeled feature input with the known prediction.

In another implementation, the artificial intelligence model may update its configurations (e.g., weights, biases, or other parameters) based on the assessment of its prediction and reference feedback information (e.g., user indication of accuracy, reference labels, or other information). In another implementation, where the artificial intelligence model is a neural network, connection weights may be adjusted to reconcile differences between the neural network's prediction and the reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the artificial intelligence model may be trained to generate better predictions.

In some implementations, the artificial intelligence model may include an artificial neural network. In such implementations, the artificial intelligence model may include an input layer and one or more hidden layers. Each neural unit of the artificial intelligence model may be connected with many other neural units of the artificial intelligence model. Such connections can be enforcing or inhibitory in their effect on the activation state of connected neural units. In some implementations, each individual neural unit may have a summation function that combines the values of all of its inputs together. In some implementations, each connection (or the neural unit itself) may have a threshold function that the signal must surpass before it propagates to other neural units. The artificial intelligence model may be self-learning and trained, rather than explicitly programmed, and can perform significantly better in certain areas of problem solving as compared to traditional computer programs. During training, an output layer of the artificial intelligence model may correspond to a classification of the artificial intelligence model, and an input known to correspond to that classification may be input into an input layer of the artificial intelligence model during training. During testing, an input without a known classification may be input into the input layer, and a determined classification may be output.

In some implementations, the artificial intelligence model may include multiple layers (e.g., where a signal path traverses from front layers to back layers). In some implementations, backpropagation techniques may be utilized by the artificial intelligence model where forward stimulation is used to reset weights on the “front” neural units. In some implementations, stimulation and inhibition for the artificial intelligence model may be more free flowing, with connections interacting in a more chaotic and complex fashion. During testing, an output layer of the artificial intelligence model may indicate whether or not a given input corresponds to a classification of the artificial intelligence model.

System 400 also includes application programming interface (API) layer 450. API layer 450 may allow the system to communicate across different devices. In some implementations, API layer 450 may be implemented on mobile device 422 or user terminal 424. Alternatively or additionally, API layer 450 may reside on one or more of cloud components 410. API layer 450 (which may be a REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web services, using resources like Service Repository and Developer Portal, but with low governance, standardization, and separation of concerns. Alternatively, system 400 may be fully based on API layer 450, such that separation of concerns between layers like API layer 450, services, and applications are in place.

In some implementations, the system architecture may use a microservice approach. Such systems may use two types of layers: Front-End Layer and Back-End Layer, where microservices reside. In this kind of architecture, the role of the API layer 450 may provide integration between the Front-End Layer and the Back-End Layer. In such cases, API layer 450 may use RESTful APIs (exposition to front-end or event communication between microservices). API layer 450 may use AMQP (e.g., Kafka, RabbitMQ, etc.). API layer 450 may use incipient usage of new communication protocols such as gRPC, Thrift, etc.

In some implementations, the system architecture may use an open API approach. In such cases, API layer 450 may use commercial or open-source API platforms and their modules. API layer 450 may use a developer portal. API layer 450 may use strong security constraints applying WAF and DDoS protection, and API layer 450 may use RESTful APIs as standard for external integration.

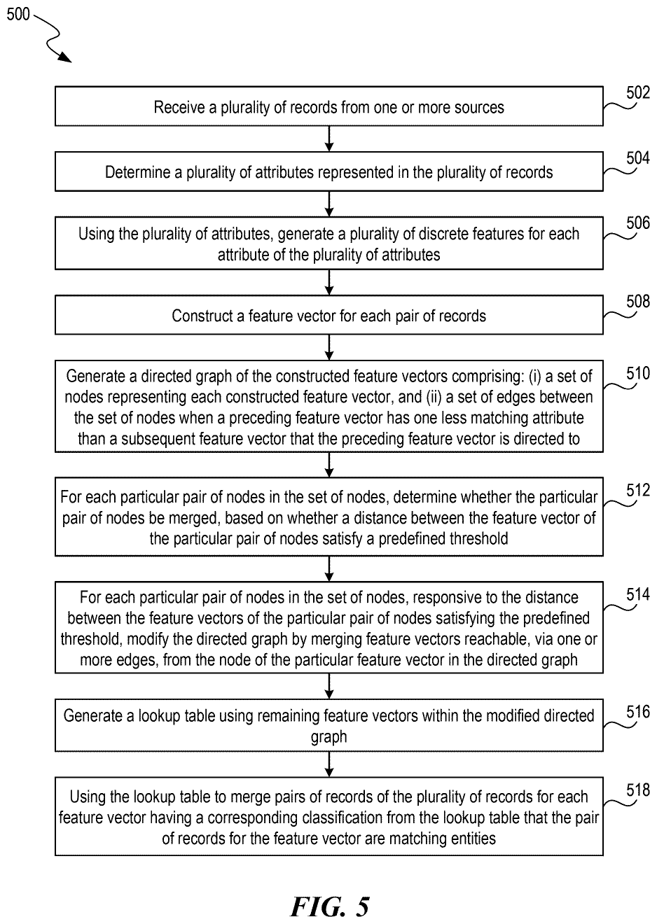

FIG. 5 shows a flowchart of the operations involved in performing entity resolution for a plurality of records, in accordance with one or more implementations. For example, process 500 may represent the operations taken by one or more devices discussed in relation to FIGS. 1-4. In some implementations, process 500 may be executed independent of a blocking key for performing entity resolution for the plurality of records.

At operation 502, process 500 (e.g., using one or more components in system 400 (FIG. 4)) can obtain a plurality of records from one or more sources. The records may come from various databases, CRM systems, or other data repositories. The process 500 can interface with different data sources using APIs, database connectors, and/or data integration tools to obtain the records. For example, process 500 may obtain a plurality of records from one or more sources as shown with respect to FIG. 1. The obtained records can be from different sources, or from the same source.

At operation 504, process 500 can determine a plurality of attributes represented in the plurality of records. For example, process 500 may determine a plurality of attributes represented in the plurality of records as shown with respect to FIGS. 1-4. An attribute is information that describes a characteristic or property of an entity within a record. Attributes can be the fields or columns in a dataset that hold the data points used for comparison during the entity resolution process. The attributes can include fields such as name, address, email, TaxID, phone number, and other relevant identifiers. Attributes can have different data types, such as strings (text), numbers (integers or floating-point), dates, or Boolean values. The data type of an attribute determines the kind of operations that can be performed on it. For example, a “Date of Birth” attribute can have a date data type, while a “Phone Number” attribute can be a string.

At operation 506, process 500 can generate a plurality of discrete features for each attribute of the plurality of attributes. For example, process 500 can compare corresponding attributes between pairs of records of the plurality of records. Process 500 can determine whether the corresponding attributes between the pairs of records match. For instance, process 500 compares a name attribute of a first record and a second record. If both names match, a binary feature (1) is generated; otherwise, a binary feature (0) is generated. The discrete features can be trinary (0, 1, 2) or continuous values. For example, a trinary feature can represent an exact match (2), a partial match (1), or no match (0). Continuous values can represent the degree of similarity on a scale from 0 to 1.

To generate the discrete features, process 500 may use various matching algorithms, such as exact match, fuzzy match, and/or phonetic match, to compare attributes and generate discrete features. For example, an exact match algorithm checks if attributes are identical in both records (e.g., “John Smith” in one record must exactly match “John Smith” in another record for a binary feature (1) to be generated). In another example, the process 500 can calculate a similarity score between attributes and determine a match if the score exceeds a certain threshold. For example, “John Smith” and “Jon Smith” can be considered a match if the similarity score exceeds a certain threshold. The similarity score can be calculated using techniques such as Levenshtein distance, which measures the number of single-character edits required to change one string into another, and/or Jaro-Winkler distance, which accounts for the number and order of matching characters. Further, the process 500 can convert attributes into phonetic codes based on how the attributes sound to match attributes that sound similar but are spelled differently (e.g., “John” and “Jon”).

At operation 508, process 500 can construct a feature vector for each pair of records. Each match vector includes corresponding discrete features of the pair of records. For example, process 500 may generate a plurality of match vectors based on the plurality of attributes as shown with respect to FIGS. 1-4. For example, if the first record and the second record have matching names and addresses but different emails and TaxIDs, the feature vector can be (1, 1, 0, 0) using binary discrete features. The feature vectors capture the similarity and dissimilarity between pairs of records across multiple attributes.

At operation 510, process 500 can generate a directed graph of the constructed feature vectors including: (i) a set of nodes representing each constructed feature vector, and (ii) a set of edges between the set of nodes when a preceding feature vector has one less matching attribute than a subsequent feature vector that the preceding feature vector is directed to. The directed graph, as illustrated in FIG. 2A and FIG. 2B, visually represents the relationships between feature vectors. For example, a node can represent the feature vector (1, 1, 0, 0), indicating matches in the first two attributes and mismatches in the last two. Edges in the graph connect nodes based on the number of matching attributes. Specifically, an edge can be drawn from a node with fewer matching attributes to a node with one additional matching attribute to create a hierarchical structure where nodes with fewer matches point to nodes with more matches. For instance, a node representing the feature vector (1, 0, 0, 0) can have edges pointing to nodes representing (1, 1, 0, 0), (1, 0, 1, 0), and (1, 0, 0, 1).

At operation 512, for each particular pair of nodes in the set of nodes, process 500 can determine whether the particular pair of nodes be merged, based on whether a distance between the feature vector of the particular pair of nodes satisfies a predefined threshold. The distance metric can be based on similarity measures such as Jaccard similarity, Jaro-Winkler distance, or Euclidean distance. The process 500 evaluates the similarity between feature vectors to determine if the feature vectors represent the same entity. For example, if two feature vectors are (1, 1, 0, 0) and (1, 1, 1, 0), the Jaccard similarity can be the size of the intersection (2) divided by the size of the union (3), resulting in a similarity score of ⅔.

At operation 514, for each particular pair of nodes in the set of nodes, process 500 can, in response to the distance between the feature vectors of the particular pair of nodes satisfying the predefined threshold, modify the directed graph by merging feature vectors reachable, via one or more edges, from the node of the particular feature vector in the directed graph. The modification of the directed graph, depicted in FIG. 2B, consolidates nodes that are determined to represent the same entity, simplifying the graph structure.

When the distance between the feature vectors of a particular pair of nodes meets the predefined threshold, it indicates a high degree of similarity between the records represented by these nodes. In such cases, process 500 merges the nodes to reflect that the records likely represent the same entity. Reachable nodes are those that can be accessed via one or more edges from the current node. For example, if a first node is connected to a second node, and the second node is connected to a third node, then the second and third nodes are reachable from the first node. By merging nodes that represent the same entity, the graph becomes interpretable. Additionally, the merging process ensures that the monotonicity constraints (and thereby logical consistency of the model) are maintained, since feature vectors with more matching attributes are classified as at least as likely to represent matching entities as those with fewer matching attributes.

At operation 516, process 500 can generate a lookup table (i.e., an entity resolution model) using remaining feature vectors within the modified directed graph. The lookup table may map each remaining feature vector of the modified directed graph to a classification indicating either matching entities or non-matching entities. The entity resolution model can be trained to output a binary indicator (e.g., as shown with respect to FIG. 3) regarding whether pairs of records for a match vector be merged. In some implementations, as opposed to a lookup table, the entity resolution model may include a decision tree model, an XGBoost model, or a classification model. The lookup table can provide a binary indicator for each feature vector. The binary indicator specifies whether the records associated with the feature vector should be merged (indicating a match) or kept separate (indicating no match). For example, a feature vector (1, 1, 0, 0) can be classified as a match, while a feature vector (0, 0, 1, 1) may be classified as a non-match.

At operation 518, using the lookup table, process 500 can merge pairs of records of the plurality of records for each feature vector having a corresponding classification from the lookup table that the pair of records for the feature vector are matching entities. The lookup table can contain pre-determined classifications for each feature vector, indicating whether the records associated with that feature vector should be considered as matching entities or non-matching entities. For each generated feature vector, process 500 can consult the lookup table to determine the feature vector's classification. If the lookup table indicates that the feature vector corresponds to matching entities, the system proceeds to merge the pair of records by consolidating the information from both records into a single, unified record. For example, if two records have the same name and address but different phone numbers, the merged record can include both phone numbers.

It is contemplated that the operations or descriptions of FIG. 5 may be used with any other implementation of this disclosure. In addition, the operations and descriptions described in relation to FIG. 5 may be done in alternative orders or in parallel to further the purposes of this disclosure. For example, each of these operations may be performed in any order, in parallel, or simultaneously to reduce lag or increase the speed of the system or method. Furthermore, it should be noted that any of the devices or equipment discussed in relation to FIGS. 1-4 could be used to perform one or more of the operations in FIG. 5.

The above-described implementations of the present disclosure are presented for purposes of illustration and not of limitation, and the present disclosure is limited only by the claims that follow. Furthermore, it should be noted that the features and limitations described in any one implementation may be applied to any other implementation herein, and flowcharts or examples relating to one implementation may be combined with any other implementation in a suitable manner, done in different orders, or done in parallel. In addition, the systems and methods described herein may be performed in real time. It should also be noted that the systems and/or methods described above may be applied to, or used in accordance with, other systems and/or methods.

The present techniques for performing entity resolution for a plurality of records will be better understood with reference to the following enumerated implementations:
1. A method for training entity resolution models using monotonicity constraints, the method comprising: receiving a plurality of records from one or more sources; determining a plurality of attributes represented in the plurality of records; using the plurality of attributes, generating a plurality of discrete features for each attribute of the plurality of attributes by: (i) comparing corresponding attributes between pairs of records of the plurality of records, and (ii) determining whether the corresponding attributes between the pairs of records match; constructing a feature vector for each pair of records, wherein the feature vector comprises corresponding discrete features of the pair of records; generating a directed graph of the constructed feature vectors comprising: (i) a set of nodes representing each constructed feature vector, and (ii) a set of edges between the set of nodes when a preceding feature vector has one less matching attribute than a subsequent feature vector that the preceding feature vector is directed to; for each particular pair of nodes in the set of nodes: determining whether the particular pair of nodes be merged, based on whether a distance between the feature vector of the particular pair of nodes satisfy a predefined threshold, and responsive to the distance between the feature vectors of the particular pair of nodes satisfying the predefined threshold, modifying the directed graph by merging feature vectors reachable, via one or more edges, from the node of the particular feature vector in the directed graph; generating a lookup table using remaining feature vectors within the modified directed graph, wherein the lookup table maps each remaining feature vector of the modified directed graph to a classification indicating either matching entities or non-matching entities; and using the lookup table to merge pairs of records of the plurality of records for each feature vector having a corresponding classification from the lookup table that the pair of records for the feature vector are matching entities.
2. A method for training entity resolution models using monotonicity constraints, the method comprising: using a plurality of attributes represented in a plurality of records, constructing a feature vector for each pair of records based on whether corresponding attributes between pairs of records in the plurality of records match; generating a directed graph of the constructed feature vectors comprising: (i) a set of nodes representing each constructed feature vector, and (ii) a set of edges between the set of nodes when a preceding feature vector has fewer matching attributes than a subsequent feature vector that the preceding feature vector is directed to; for each particular pair of nodes in the set of nodes, responsive to a degree of similarity between the feature vectors of the particular pair of nodes satisfying a predefined threshold, modifying the directed graph by merging feature vectors reachable, via one or more edges, from the node of the particular feature vector in the directed graph; and generating a lookup table using remaining feature vectors within the modified directed graph, wherein the lookup table maps each remaining feature vector of the modified directed graph to a classification indicating either matching entities or non-matching entities.
3. A method for training entity resolution models using monotonicity constraints, the method comprising: using an entity resolution model to merge a pair of records based on a feature vector for the pair of records having a corresponding classification from the entity resolution model that the pair of records are matching entities, wherein, using one or more of attributes represented in a plurality of records, feature vectors are constructed for each pair of records based on whether corresponding attributes between pairs of records in the plurality of records match, wherein a directed graph of the constructed feature vectors is generated comprising: (i) a set of nodes representing each constructed feature vector, and (ii) a set of edges between the set of nodes, wherein, for each particular pair of nodes in the set of nodes, the directed graph is modified by merging feature vectors reachable, via one or more edges, from the node of the particular feature vector in the directed graph, and wherein the entity resolution model is generated using remaining feature vectors within the modified directed graph.
4. The method of any one of the preceding implementations, wherein the plurality of discrete features for each attribute of the plurality of attributes include one or more of: binary features or trinary features, wherein, based on a particular discrete feature of the particular feature vector being binary, determining whether the particular pair of nodes be merged includes determining whether the particular discrete features of the particular pairs of nodes are both equal to one, and wherein, based on a particular discrete feature of the particular feature vector being trinary, determining whether the particular pair of nodes be merged includes determining whether the particular discrete features of the particular pairs of nodes are both equal to two.
5. The method of any one of the preceding implementations, wherein the degree of similarity between the feature vectors of the particular pair of nodes is determined using a distance metric including one or more of: Jaccard similarity, Jaro-Winkler distance, or Euclidean distance.
6. The method of any one of the preceding implementations, wherein the degree of similarity between the feature vectors of the particular pair of nodes is determined using cosine similarity.
7. The method of any one of the preceding implementations, further comprising: using the lookup table to merge pairs of records of the plurality of records for each feature vector having a corresponding classification from the lookup table that the pair of records for the feature vector are matching entities.
8. The method of any one of the preceding implementations, wherein mapping each remaining feature vector of the modified directed graph further comprises: calculating a first number of the feature vectors reachable, via one or more edges, from the node of the remaining feature vector in the modified directed graph classified as matching entities, calculating a second number of the feature vectors reachable, via one or more edges, from the node of the remaining feature vector in the modified directed graph, and determining the classification of the remaining feature vector based on whether a fraction of the first number and the second number exceeds the predefined threshold.
9. The method of any one of the preceding implementations, further comprising: biasing towards classifications indicating non-matching entities by increasing the predefined threshold of the degree of similarity between the feature vectors of the particular pair of nodes.
10. The method of any one of the preceding implementations, wherein the feature vectors are binary vectors or trinary vectors.
11. The method of any one of the preceding implementations, wherein constructing the feature vector for each pair of records further comprises: using one or more models to determine whether the corresponding attributes between the pairs of records match, wherein the one or more models include at least one of: a decision tree, a random forest, a Bayesian network, a support vector machine, or a logistic regression model.
12. The method of any one of the preceding implementations, wherein the directed graph is modified based on whether the feature vectors of the particular pair of nodes satisfy a predefined threshold, wherein the predefined threshold for merging the feature vectors is determined using a majority vote between classifications of neighboring feature vectors of the directed graph.
13. The method of any one of the preceding implementations, wherein each particular node in the directed graph has an edge pointing to every feature vector that indicates a presence of one more matching attribute than the particular node.
14. The method of any one of the preceding implementations, wherein constructing the feature vector for each pair of records further comprises: using one or more models to determine whether the corresponding attributes between the pairs of records match, wherein the one or more models assigns a weight to each attributes of the one or more attributes to bias the determination towards higher weighted attributes.
15. The method of any one of the preceding implementations, wherein constructing the feature vector for each pair of records includes assigning a confidence score to each element of the feature vectors, wherein the directed graph is modified based on whether the feature vectors of the particular pair of nodes satisfy a predefined threshold, further comprising: using the confidence score to dynamically adjust the predefined threshold.
16. The method of any one of the preceding implementations, wherein constructing the feature vector for each pair of records comprises: determining a plurality of attributes represented in the plurality of records, and using the plurality of attributes, generating a plurality of discrete features for each attribute of the plurality of attributes by: (i) comparing corresponding attributes between pairs of records of the plurality of records, and (ii) determining whether the corresponding attributes between the pairs of records match.
17. The method of any one of the preceding implementations, wherein the directed graph is modified based on whether the feature vectors of the particular pair of nodes satisfy a predefined threshold, the operations further comprising: biasing towards classifications indicating non-matching entities by increasing the predefined threshold between the feature vectors of the particular pair of nodes.
18. The method of any one of the preceding implementations, wherein the directed graph is modified based on whether the feature vectors of the particular pair of nodes satisfy a predefined threshold, the operations further comprising: biasing towards classifications indicating matching entities by decreasing the predefined threshold between the feature vectors of the particular pair of nodes.
19. The method of any one of the preceding implementations, wherein mapping each remaining feature vector of the modified directed graph further comprises: calculating a first number of the feature vectors reachable, via one or more edges, from the node of the remaining feature vector in the modified directed graph classified as matching entities, calculating a second number of the feature vectors reachable, via one or more edges, from the node of the remaining feature vector in the modified directed graph, and determining the classification of the remaining feature vector based on whether a fraction of the first number and the second number exceeds a predefined threshold.
20. One more non-transitory, computer-readable media storing instructions that, when executed by a data processing apparatus, cause the data processing apparatus to perform operations comprising those of any of implementations 1-19.
21. A system comprising: one or more processors; and memory storing instructions that, when executed by the processors, cause the processors to effectuate operations comprising those of any of implementations 1-19.
22. A system comprising means for performing any of implementations 1-19.

What is claimed is:

1. A system for training entity resolution models using monotonicity constraints, the system comprising:
one or more processors; and
one or more non-transitory, computer-readable media comprising instructions that, when executed by the one or more processors, cause operations comprising:
receiving a plurality of records from one or more sources;
determining a plurality of attributes represented in the plurality of records;
using the plurality of attributes, generating a plurality of discrete features for each attribute of the plurality of attributes by:
(i) comparing corresponding attributes between pairs of records of the plurality of records, and
(ii) determining whether the corresponding attributes between the pairs of records match;
constructing a feature vector for each pair of records, wherein the feature vector comprises corresponding discrete features of the pair of records;
generating a directed graph of the constructed feature vectors comprising: (i) a set of nodes representing each constructed feature vector, and (ii) a set of edges between the set of nodes when a preceding feature vector has one less matching attribute than a subsequent feature vector that the preceding feature vector is directed to;
for each particular pair of nodes in the set of nodes:
determining whether the particular pair of nodes be merged, based on whether a distance between the feature vector of the particular pair of nodes satisfy a predefined threshold, and
responsive to the distance between the feature vectors of the particular pair of nodes satisfying the predefined threshold, modifying the directed graph by merging feature vectors reachable, via one or more edges, from the node of the particular feature vector in the directed graph;
generating a lookup table using remaining feature vectors within the modified directed graph, wherein the lookup table maps each remaining feature vector of the modified directed graph to a classification indicating either matching entities or non-matching entities; and
using the lookup table to merge pairs of records of the plurality of records for each feature vector having a corresponding classification from the lookup table that the pair of records for the feature vector are matching entities.

2. The system of claim 1,
wherein the plurality of discrete features for each attribute of the plurality of attributes include one or more of: binary features or trinary features,
wherein, based on a particular discrete feature of the particular feature vector being binary, determining whether the particular pair of nodes be merged includes determining whether the particular discrete features of the particular pairs of nodes are both equal to one, and
wherein, based on a particular discrete feature of the particular feature vector being trinary, determining whether the particular pair of nodes be merged includes determining whether the particular discrete features of the particular pairs of nodes are both equal to two.

3. A method, the method comprising:
using a plurality of attributes represented in a plurality of records, constructing a feature vector for each pair of records based on whether corresponding attributes between pairs of records in the plurality of records match;
generating a directed graph of the constructed feature vectors comprising: (i) a set of nodes representing each constructed feature vector, and (ii) a set of edges between the set of nodes when a preceding feature vector has fewer matching attributes than a subsequent feature vector that the preceding feature vector is directed to;
for each particular pair of nodes in the set of nodes, responsive to a degree of similarity between the feature vectors of the particular pair of nodes satisfying a predefined threshold, modifying the directed graph by merging feature vectors reachable, via one or more edges, from the node of the particular feature vector in the directed graph; and
generating a lookup table using remaining feature vectors within the modified directed graph, wherein the lookup table maps each remaining feature vector of the modified directed graph to a classification indicating either matching entities or non-matching entities.

4. The method of claim 3, wherein the degree of similarity between the feature vectors of the particular pair of nodes is determined using a distance metric including one or more of: Jaccard similarity, Jaro-Winkler distance, or Euclidean distance.

5. The method of claim 3, wherein the degree of similarity between the feature vectors of the particular pair of nodes is determined using cosine similarity.

6. The method of claim 3, further comprising:
using the lookup table to merge pairs of records of the plurality of records for each feature vector having a corresponding classification from the lookup table that the pair of records for the feature vector are matching entities.

7. The method of claim 3, wherein mapping each remaining feature vector of the modified directed graph further comprises:
calculating a first number of the feature vectors reachable, via one or more edges, from the node of the remaining feature vector in the modified directed graph classified as matching entities,
calculating a second number of the feature vectors reachable, via one or more edges, from the node of the remaining feature vector in the modified directed graph, and
determining the classification of the remaining feature vector based on whether a fraction of the first number and the second number exceeds the predefined threshold.

8. The method of claim 3, further comprising:
biasing towards classifications indicating non-matching entities by increasing the predefined threshold of the degree of similarity between the feature vectors of the particular pair of nodes.

9. The method of claim 3, further comprising:
biasing towards classifications indicating matching entities by decreasing the predefined threshold of the degree of similarity between the feature vectors of the particular pair of nodes.

10. The method of claim 3, wherein the feature vectors are binary vectors or trinary vectors.

11. The method of claim 3, wherein constructing the feature vector for each pair of records further comprises:
using one or more models to determine whether the corresponding attributes between the pairs of records match, wherein the one or more models include at least one of: a decision tree, a random forest, a Bayesian network, a support vector machine, or a logistic regression model.

12. One or more non-transitory, computer-readable media comprising instructions that, when executed by one or more processors, cause operations comprising:
using an entity resolution model to merge a pair of records based on a feature vector for the pair of records having a corresponding classification from the entity resolution model that the pair of records are matching entities,
wherein, using one or more of attributes represented in a plurality of records, feature vectors are constructed for each pair of records based on whether corresponding attributes between pairs of records in the plurality of records match,
wherein a directed graph of the constructed feature vectors is generated comprising:
(i) a set of nodes representing each constructed feature vector, and (ii) a set of edges between the set of nodes,
wherein, for each particular pair of nodes in the set of nodes, the directed graph is modified by merging feature vectors reachable, via one or more edges, from the node of the particular feature vector in the directed graph, and
wherein the entity resolution model is generated using remaining feature vectors within the modified directed graph.

13. The one or more non-transitory, computer-readable media of claim 12,
wherein the directed graph is modified based on whether the feature vectors of the particular pair of nodes satisfy a predefined threshold,
wherein the predefined threshold for merging the feature vectors is determined using a majority vote between classifications of neighboring feature vectors of the directed graph.

14. The one or more non-transitory, computer-readable media of claim 12, wherein each particular node in the directed graph has an edge pointing to every feature vector that indicates a presence of one more matching attribute than the particular node.

15. The one or more non-transitory, computer-readable media of claim 12, wherein constructing the feature vector for each pair of records further comprises:
using one or more models to determine whether the corresponding attributes between the pairs of records match, wherein the one or more models assigns a weight to each attributes of the one or more attributes to bias the determination towards higher weighted attributes.

16. The one or more non-transitory, computer-readable media of claim 12,
wherein constructing the feature vector for each pair of records includes assigning a confidence score to each element of the feature vectors,
wherein the directed graph is modified based on whether the feature vectors of the particular pair of nodes satisfy a predefined threshold, further comprising:
using the confidence score to dynamically adjust the predefined threshold.

17. The one or more non-transitory, computer-readable media of claim 12, wherein constructing the feature vector for each pair of records comprises:
determining a plurality of attributes represented in the plurality of records, and
using the plurality of attributes, generating a plurality of discrete features for each attribute of the plurality of attributes by:
(i) comparing corresponding attributes between pairs of records of the plurality of records, and
(ii) determining whether the corresponding attributes between the pairs of records match.

18. The one or more non-transitory, computer-readable media of claim 12, wherein the directed graph is modified based on whether the feature vectors of the particular pair of nodes satisfy a predefined threshold, the operations further comprising:
biasing towards classifications indicating non-matching entities by increasing the predefined threshold between the feature vectors of the particular pair of nodes.

19. The one or more non-transitory, computer-readable media of claim 12, wherein the directed graph is modified based on whether the feature vectors of the particular pair of nodes satisfy a predefined threshold, the operations further comprising:
biasing towards classifications indicating matching entities by decreasing the predefined threshold between the feature vectors of the particular pair of nodes.

20. The one or more non-transitory, computer-readable media of claim 12, wherein mapping each remaining feature vector of the modified directed graph further comprises:
calculating a first number of the feature vectors reachable, via one or more edges, from the node of the remaining feature vector in the modified directed graph classified as matching entities,
calculating a second number of the feature vectors reachable, via one or more edges, from the node of the remaining feature vector in the modified directed graph, and
determining the classification of the remaining feature vector based on whether a fraction of the first number and the second number exceeds a predefined threshold.
